(19) United States
(12) Patent Application Publication
(10) Pub. No.: US 2007/0026931 A1
(43) Pub. Date: Feb. 1, 2007

(54) Gaming machine

(75) Inventor: Masatsugu Kobayashi, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/491,481

(22) Filed: Jul. 24, 2006

(30) Foreign Application Priority Data
Jul. 25, 2005 (JP) P2005-213941

(51) Int. Cl. A63F 13/00

(52) U.S. Cl. 463/20

(57) ABSTRACT

A gaming machine includes: a first display; a second display; a processor controlling the first and second displays; and an operation unit for a player to input a start command. A lottery is performed to determine a stop state of symbols. When the start command is input, the first display performs a variable display of a plurality of symbols. A next start command is input starting a next game, whereupon the present game moves to and continues in the second display. The first display then performs the variable display for the next game while the present game is continued in the second display. The second display stops performing the variable display and displays the symbols in the stop state determined by the lottery. A payout of an award to the player is made in accordance with the stop state of the symbols.

### CROSS-REFERENCE TO THE RELATED APPLICATION(S)

The present application is based upon and claims priority from prior Japanese Patent Application No. 2005-213941, filed on Jul. 25, 2005, the entire contents of which are incorporated herein by reference.

### TECHNICAL FIELD

The present invention relates to a gaming machine for performing variable display and stop displaying the variable display of symbols by a display device.

### BACKGROUND

In conventional gaming machines, mainly in slot machines directed to overseas market, when a player presses a spin switch, a lottery is held and reels start to rotate and automatically stop after the expiration of a given time, and display the symbols stopped in accordance with the result of the lottery, whereby a base game proceeds.

In the slot machines, some players may feel that a sequence of a game effect (game presentation) from rotation of the reels to the automatic stop of the reels, is long. In a case where the player feels that similar game effect continues for a long time, the player gets tired of the game effect. Generally, when the player recognizes the initial part of the game effect, the player can roughly predict the result of the game, and thus feels to start the next game before the present game is completed.

Accordingly, there is proposed a gaming machine that allows the player to cancel the game effect in the present game, to notify the player only the result of the present game, and to start the next game. For example, a document JP-A-2004-000694 discloses a gaming machine for satisfying demand for starting the next-game by canceling the game effect in the present game, and demand for enjoying the game effect in the present game, and for allowing the player to cancel the game effect as the player selects. A document JP-A-2004-267648 discloses a gaming machine for allowing the player to skip the game effect in a free game.

However, the game effects which seem to be the same may differ in a content of the game effect (particularly in a latter half part) in response to a winning combination and a state of the game. Therefore, there is a player's demand to perform transition to the next game while the game effect in the present game is performed.

### SUMMARY

According to a first aspect of the invention, there is provided a gaming machine including: a first image display device; a second image display device; a processor that performs a process for providing a player a game by controlling the first image display device and the second image display device to display a progress of the game; and an operation unit that allows the player to input operations including a start command to start the game. The processor performs the process including: performing a lottery to determine a stop state of symbols when the start command is input through the operation unit; controlling the first image display device to start performing a variable display of a plurality of symbols when the start command is input through the operation unit; accepting a next start command input through the operation unit for starting a next game, while the variable display of a present game is performed in the first image display device; continuing the present game in the second image display device by controlling the second image display device to carry on the variable display performed in the first image display device, when the next start command is accepted; controlling the first image display device to start performing the variable display for the next game while the present game is continued in the second image display device; controlling the second image display device to stop performing the variable display and to display the symbols in the stop state determined by the lottery; and performing a payout of an award to the player in accordance with the stop state of the symbols. According to a second aspect of the invention, there is provided a gaming machine including: a first image display device; a second image display device; a processor that performs a process for providing a player a game by controlling the first image display device and the second image display device to display a progress of the game; and an operation unit that allows the player to input operations including a start command to start the game. The processor performs the process including: performing a lottery to determine a stop state of symbols when the start command is input through the operation unit; controlling the first image display device to start performing a variable display of a plurality of symbols when the start command is input through the operation unit; accepting a next start command input through the operation unit for starting a next game, while the variable display of a present game is performed in the first image display device; continuing the present game in the second image display device by controlling the second image display device to carry on the variable display performed in the first image display device, when the next start command is accepted; controlling the first image display device to start performing the variable display for the next game while the present game is continued in the second image display device; controlling the second image display device to stop performing the variable display and to display the symbols in the stop state determined by the lottery; and performing a payout of an award to the player in accordance with the stop state of the symbols. The processor performs continuing the present game in the second image display device and controlling the first image display device to start performing the variable display for the next game, after completion of stop performing the variable display for a previous game in the second image display device, when the next start command is accepted while the variable display for the previous game is performed in the second image display device.

According to a third aspect of the invention, there is provided a gaming machine including: a first image display device; a second image display device; a processor that performs a process for providing a player a game by controlling the first image display device and the second image display device to display a progress of the game; and an operation unit that allows the player to input operations including a start command to start the game. The processor performs the process including: performing a lottery to determine a stop state of symbols when the start command is input through the operation unit; controlling the first image display device to start performing a variable display of a plurality of symbols when the start command is input through the operation unit; accepting a next start command input through the operation unit for starting a next game, while the variable display of a present game is performed in the first image display device; continuing the present game in the second image display device by controlling the second image display device to carry on the variable display performed in the first image display device, when the next start command is accepted; controlling the first image display device to start performing the variable display for the next game while the present game is continued in the second image display device; controlling the second image display device to stop performing the variable display and to display the symbols in the stop state determined by the lottery; and performing a payout of an award to the player in accordance with the stop state of the symbols. The processor performs continuing the present game in the second image display device and controlling the first image display device to start performing the variable display for the next game, after completion of stop performing the variable display for a previous game in the second image display device, when the next start command is accepted while the variable display for the previous game is performed in the second image display device. The processor immediately performs controlling the second image display device to stop performing the variable display for the previous game, when the next start command is accepted while the variable display for the previous game is performed in the second image display device.

According to a fourth aspect of the invention, there is provided a method for providing a player a game with a gaming machine by controlling a first image display device and a second image display device that are provided on the gaming machine to display a progress of the game. The method includes: performing a lottery to determine a stop state of symbols when a start command is input by the player; controlling the first image display device to start performing a variable display of a plurality of symbols when the start command is input by the player; accepting a next start command input through the operation unit for starting a next game, while the variable display of a present game is performed in the first image display device; continuing the present game in the second image display device by controlling the second image display device to carry on the variable display performed in the first image display device, when the next start command is accepted; controlling the first image display device to start performing the variable display for the next game while the present game is continued in the second image display device; controlling the second image display device to stop performing the variable display and to display the symbols in the stop state determined by the lottery; and performing a payout of an award to the player in accordance with the stop state of the symbols.

### BRIEF DESCRIPTION OF THE DRAWINGS

In the accompanying drawings:

FIG. 1 is a drawing to show an outline of the present invention;

FIG. 2 is a perspective view of a slot machine;

FIG. 3 is a block diagram to schematically show a control system of the slot machine;

FIG. 4 is a block diagram to schematically show a liquid crystal display driving circuit of a liquid crystal display;

FIG. 5 is a drawing to describe symbol rows formed on the peripheries of reels, the symbols being variably displayed and displayed stopped while the symbol rows are scrolled on variable display sections;

FIG. 6 is a schematic representation to show a lottery table of stop display symbols for playing a game using the three variable display sections;

FIG. 7 is a schematic representation to show the winning combinations and awards for playing a game using the three variable display sections;

FIG. 8 is a flowchart of a main processing program;

FIG. 9 is a flowchart of a lottery processing program;

FIG. 10 is a flowchart of a main processing program;

FIG. 11 is a flowchart of a main processing program; and

FIG. 12 is a schematic representation to show a winning combination lottery table and awards.

### DETAILED DESCRIPTION

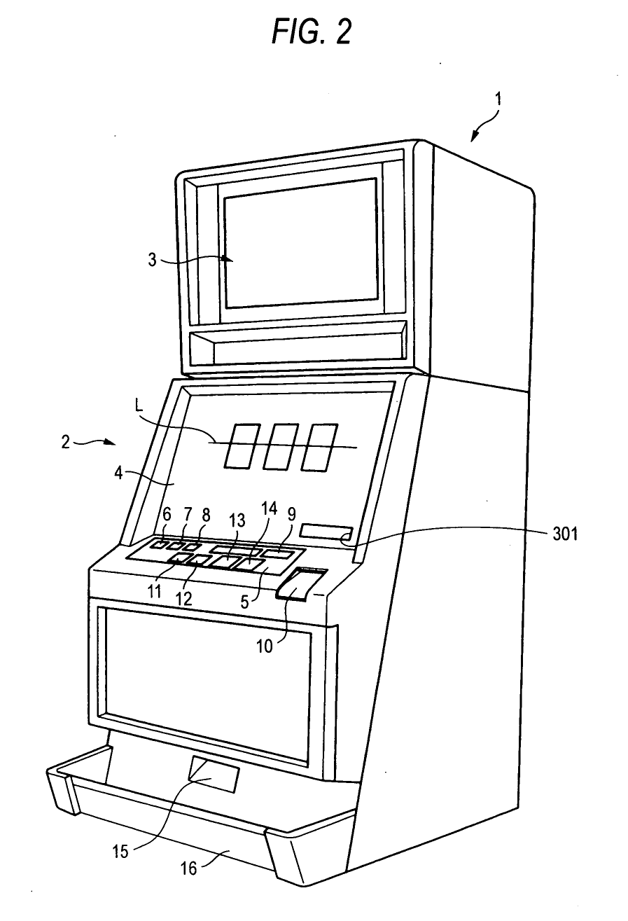

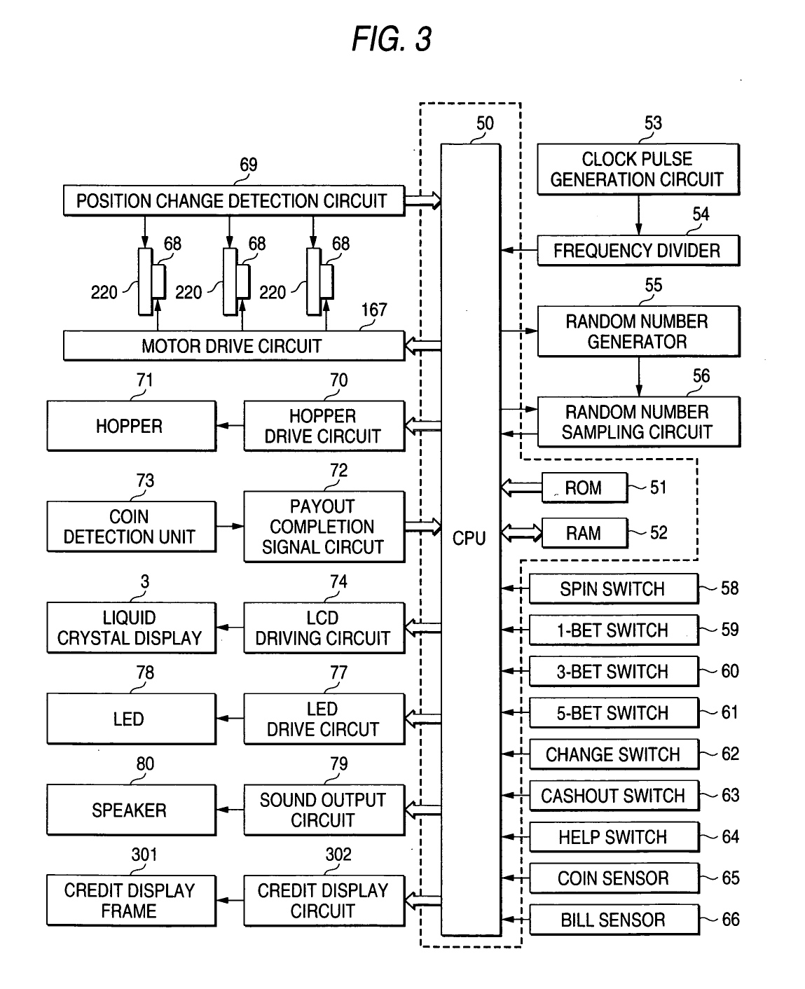

A gaming machine according to the invention will be discussed in detail with reference to the accompanying drawings based on an embodiment, which is embodied as a slot machine. In the follows, the schematic configuration of a slot machine according to the embodiment will be discussed with reference to FIGS. 2 and 3. FIG. 2 is a perspective view of the slot machine. FIG. 3 is a block diagram to schematically show a control system of the slot machine.

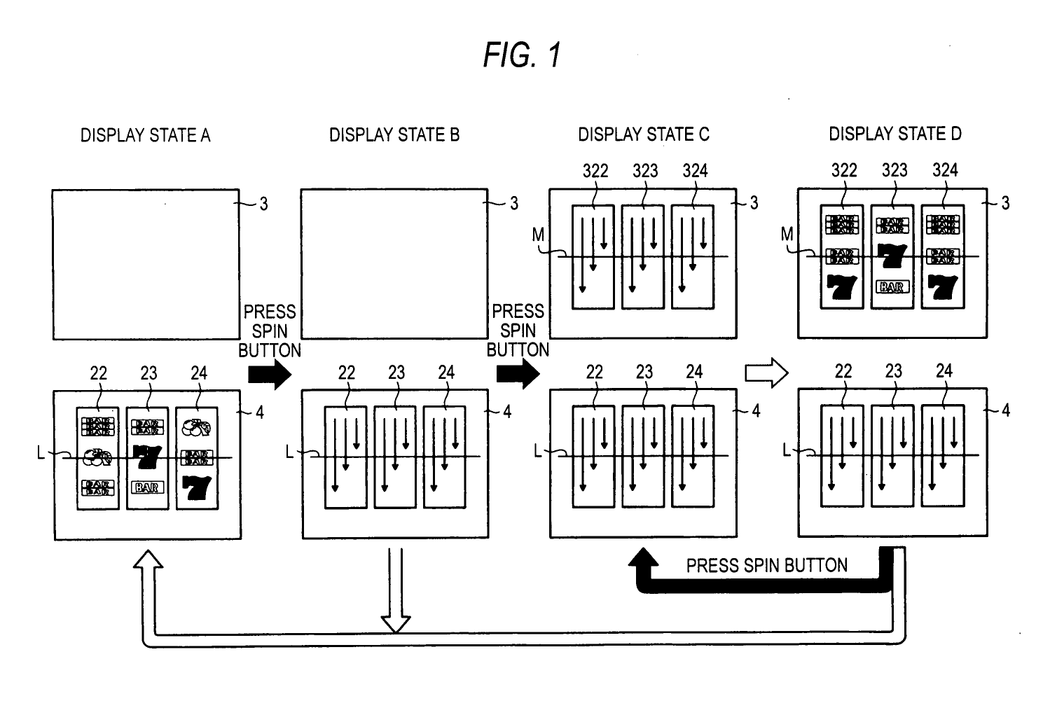

As shown in FIG. 2, a slot machine 1 is provided with a cabinet 2 forming an outer exterior of the slot machine 1, and a liquid crystal display 3 disposed on a top front part of the cabinet 2. A front panel 4 is disposed in a center front part of the cabinet 2. The liquid crystal display 3 is implemented as a generally used liquid crystal display. Information concerning a game such as a game manner, type of winning combinations, award for each of the winning combinations, and various effects concerning the game is displayed on the liquid crystal display 3. In a predetermined case, variable display and stop display of various symbols are performed (described later with reference to FIG. 1). The front panel 4 is provided with three variable display sections 22, 23, and 24 and a pay line L (activated pay line), and various symbols, which will be described later, are variably displayed on the variable display sections 22 to 24 while the symbols are scrolled from the upper direction to the lower direction (described later with reference to FIG. 1). The front panel 4 is provided with a credit display frame 301, in which a number of credit points is displayed. The credit points indicates a number of coins (game medium) obtained by the player by playing the game.

An operation table 5 projected to the front is provided below the front panel 4, and a money changing (CHANGE) button 6, a payout (CASHOUT) button 7, and a help (HELP) button 8 are arranged from the left to the right on the operation table 5. A coin insertion slot 9 and a bill insertion slot 10 are provided to the right of the help button 8. A 1-BET button 11, a spin (SPIN/REPEAT BET) button 12, a 3-BET button 13, and a 5-BET button 14 are placed from the left on the front side of the operation table 5.

The money changing button 6 is a button pressed by the player to exchange a bill (a game medium) input to the bill insertion slot 10, and the coins into which the bill is exchanged are paid out to a coin receiving tray 16 from a coin payout opening 15 provided in the lower part of the cabinet 2. A money changing (CHANGE) switch 62 (described later) is provided for the money changing button 6. As the money changing button 6 is pressed, a switch signal is output from the money changing switch 62 to a CPU 50 (see FIG. 3).

The payout button 7 is a button pressed by the player when the player decided to end a series of the games. When the player presses the payout button 7, the coins obtained by playing the game are paid out to the coin receiving tray 16 from the coin payout opening 15. However, since the coins obtained in each game usually are stored as the credit points, when the payout button 7 is pressed, an equivalent number of coins are paid out in exchange for the current credit points. A payout (CASHOUT) switch 63 (described later) is provided for the payout button 7. As the payout button 7 is pressed, a switch signal is output to the CPU 50 (see FIG. 3).

The help button 8 is a button pressed by the player when the player is not aware of the rules and operation manner in the game. When the player presses the HELP button 8, various pieces of help information are displayed on the liquid crystal display 3. A help (HELP) switch 64 (described later) is provided for the help button 8. As the help button 8 is pressed, a switch signal is output from the help switch 64 to the CPU 50 (see FIG. 3).

A coin sensor 65 (described later) is provided in the coin insertion slot 9. When a coin is input to the coin insertion slot 9, a coin detection signal is output through the coin sensor 65 to the CPU 50 (see FIG. 3) When a coin is input to the coin insertion slot 9, the points equivalent to the coin are added to the credit.

A bill sensor 66 (described later) is provided in the bill insertion slot 10. When a bill is input to the bill insertion slot 10, a bill detection signal is output through the bill sensor 66 to the CPU 50 (see FIG. 3). When a bill is input to the bill insertion slot 10, if the money changing button 6 is not pressed, the points equivalent to the bill are added to the credit.

The 1-BET button 11 is a button to bet one at a time each time the player presses the 1-BET button 11. A 1-BET switch 59 (described later) is provided for the 1-BET button 11. As the 1-BET button 11 is pressed, a switch signal is output from the 1-BET switch 59 to the CPU 50 (see FIG. 3).

The spin (SPIN/REPEAT BET) button 12 is a button for starting variable display of the symbols in the variable display sections 22 to 24 of the front panel 4 to start a game according to the current bet count or the preceding bet count as the spin button 12 is pressed. A spin switch 58 (described later) is provided for the spin button 12. As the spin button 12 is pressed, a switch signal is output from the spin switch 58 to the CPU 50 (see FIG. 3). The possible bet count as the spin button 12 is pressed can be 1, 2, 3 or 5.

The spin button 12 and the spin switch 58 serve as an operation unit that allow the player to input operations including a start command to start the game.

The 3-BET button 13 is a button to bet three as the 3-BET button 13 is pressed. A 3-BET switch 60 (described later) is provided for the 3-BET button 13. When the 3-BET button 13 is pressed, a switch signal is output from the 3-BET switch 60 to the CPU 50 (see FIG. 3). The 5-BET button 14 is a button to bet five as the 5-BET button 14 is pressed. A 5-BET switch 61 (described later) is provided for the 5-BET button 14. When the 5-BET button 14 is pressed, a switch signal is output from the 5-BET switch 61 to the CPU 50 (see FIG. 3).

When the player bets by operating the spin (SPIN/REPEAT BET) button 12, the 1-BET button 11, the 3-BET button 13, or the 5-BET button 14, the points equivalent to the bet count are subtracted from the credit.

In the lower part of the cabinet 2, the coin payout opening 15 is formed, and the coin receiving tray 16 for receiving coins paid out from the coin payout opening 15 is provided. A coin detection section 73 including a sensor (described later) is disposed in the coin payout opening 15 for detecting the number of coins paid out from the coin payout opening 15 (see FIG. 3).

Three reels 220 are supported in a parallel state and for separate rotation in the rear of the front panel 4 (see FIG. 3). A game is played according to the symbols on the reels 220 seen through the variable display sections 22 to 24 of the front panel 4.

Herein, the reels 220 will be discussed. Of the three reels 220, the left reel 220 (left, when viewed from the font of the slot machine 1) is opposed to the left variable display section 22 formed on the front panel 4, the center reel 220 is opposed to the center variable display section 23 formed on the front panel 4, and the right reel 220 is opposed to the right variable display section 24 formed on the front panel 4.

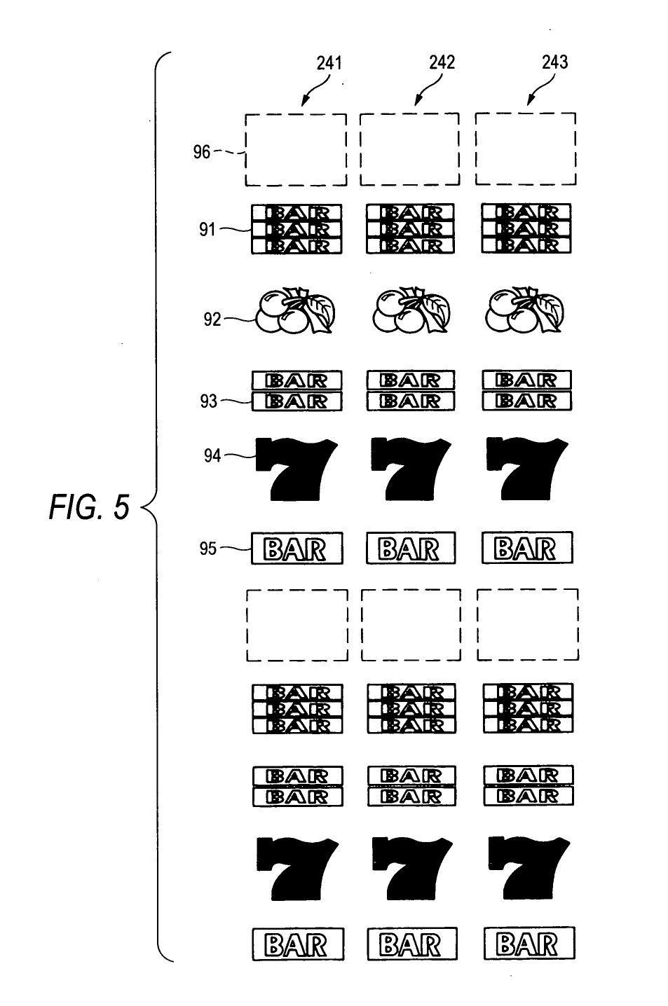

Subsequently, symbol rows formed on the peripheries of the reels 220 and variable-displayed and stop-displayed on the variable display sections 22 to 24 will be discussed based on FIG. 5. In FIG. 5, a symbol row 241 is a symbol row variable-displayed and stop-displayed on the left variable display section 22, a symbol row 242 is a symbol row variable-displayed and stop-displayed on the center variable display section 23, and a symbol row 243 is a symbol row variable-displayed and stop-displayed on the right variable display section 24.

The symbol rows 241 to 243 have the same symbol arrangement and each symbol row is made up of 11 symbols as an appropriate combination of triple BAR 91, cherry 92, double BAR 93, seven 94, single BAR 95, and blank (region with no symbol) 96.

To produce stop display of the symbol rows 241 to 243 variably displayed while being scrolled on the variable display sections 22 to 24, stop display of three symbols is performed on each of the variable display sections (see FIG. 1 mentioned later).

In the slot machine 1, various winning combinations, pursuant to combinations of the symbols of different types, are defined in advance. When the symbol combination corresponding to the winning combination stops on the activated pay line L, the points equivalent to the number of coins responsive to the winning combination are added to the credit. The description for the details of these and other features that are similar to those of the slot machines in the related arts and are not characteristic to the slot machine 1, will be omitted in the following description.

In order to place the various symbols on the periphery of each reel 220, it is a common practice to print 11 symbols on a long reel sheet matching the width and the peripheral length of each reel 220 and put the reel sheet on the periphery of each reel 220. However, the symbols can be placed on the periphery of each reel 220 by use of any other method.

Next, the configuration of a control system of the slot machine 1 will be discussed with reference to FIG. 3. FIG. 3 is a block diagram to schematically show the control system of the slot machine 1.

As shown in FIG. 3, the control system of the slot machine 1 includes the CPU 50 to which ROM 51 and RAM 52 are connected. The ROM 51 stores a main processing program, a lottery processing program, various effect programs for displaying various effects on the liquid crystal display 3 with the progress of a game, and a lottery table for drawing lots for game stop display symbols described later, and other various programs, data tables, etc., required for controlling the slot machine 1. The RAM 52 is memory for temporarily storing various pieces of data on which the CPU 50 performed operations; for example, the RAM 524 stores the credit points.

A clock pulse generation circuit 53 for generating a reference clock pulse and a frequency divider 54 are connected to the CPU 50, and a random number generator 55 for generating a random number and a random number sampling circuit 56 are also connected to the CPU 50. The random number sampled through the random number sampling circuit 56 is used for various lotteries of winning combinations, etc. Further, connected to the CPU 50 are the spin switch 58 added to the spin (SPIN/REPEAT BET) button 12, the 1-BET switch 59 added to the 1-BET button 11, the 3-BET switch 60 added to the 3-BET button 13, the 5-BET switch 61 added to the 5-BET button 14, the money changing (CHANGE) switch 62 added to the money changing button 6, the payback (CASHOUT) switch 63 (described later) added to the payout button 7, and the help (HELP) switch 64 added to the help button 8. The CPU 50 controls the slot machine to execute the operation corresponding to each button based on the switch signal output from each switch as each button is pressed.

Three stepping motors 68 for rotating the reels 220 through a motor drive circuit 167 are connected to the CPU 50, and a position change detection circuit 69 is also connected to the CPU 50. When the CPU 50 outputs a motor drive signal (command pulse) to the motor drive circuit 167, each stepping motor 68 is driven by an excitation signal output from the motor drive circuit 167. Accordingly, the reels 220 are rotated.

The CPU 50 counts the number of drive pulses supplied to each of the stepping motors 68 and keeps track of the rotation positions of the symbols on each reel 220 based on the counted number of drive pulses and performs various control such as controlling the stop position of the reels 220.

The position change detection circuit 69 is connected to the CPU 50. The position change detection circuit 69 detects change in the stop position of the reel 220 after stop control by the motor drive circuit 167 described above.

The coin sensor 65 disposed in the coin insertion slot 9 and the bill sensor 66 disposed in the bill insertion slot 10 are connected to the CPU 50. The coin sensor 65 detects a coin input from the coin insertion slot 9 and the CPU 50 calculates the number of the input coins based on a coin detection signal output from the coin sensor 65. The bill sensor 66 detects the denomination and the amount of each bill input from the bill insertion slot 10 and the CPU 50 calculates the number of coins equivalent to the amount of the bill based on a bill detection signal output from the bill sensor 66.

A hopper 71 is connected to the CPU 50 through a hopper drive circuit 70. When the CPU 50 outputs a drive signal to the hopper drive circuit 70, the hopper 71 pays out a predetermined number of coins from the coin payout opening 15.

The coin detection section 73 is connected to the CPU 50 through a payout completion signal circuit 72. The coin detection section 73 is placed in the coin payout opening 15. If the coin detection section 73 detects that a predetermined number of coins have been paid out from the coin payout opening 15, the coin detection section 7.3 outputs a coin payout detection signal to the payout completion signal circuit 72, which then outputs a payout completion signal to the CPU 50. Further, the liquid crystal display 3 is connected to the CPU 50 through a liquid crystal display driving circuit 74 and the CPU 50 controls the liquid crystal display 3.

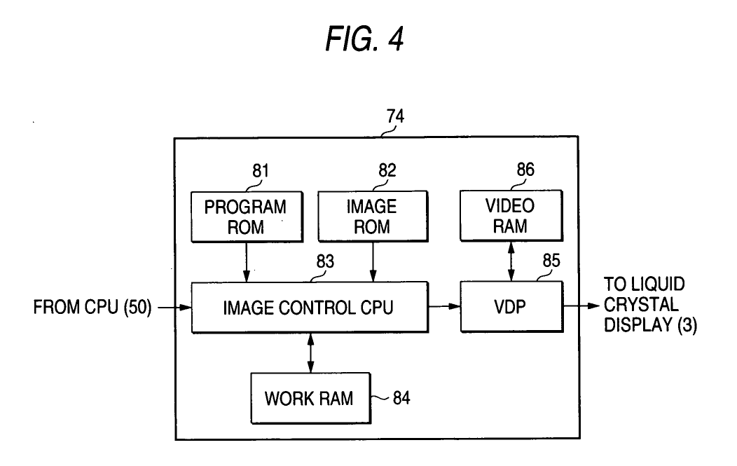

The liquid crystal display driving circuit 74 is made up of program ROM 81, image ROM 82, an image control CPU 83, work RAM 84, a VDP (video display processor) 85, video RAM 86, etc., as shown in FIG. 4. The program ROM 81 stores an image control program and various selection tables concerning display on the liquid crystal display 3. The image ROM 82 stores bitmap data (dot data) to form images such as the symbol rows 241 to 243 in FIG. 5 displayed on the liquid crystal display 3, for example. The image control CPU 83 determines the image to be displayed on the liquid crystal display 3 from the bitmap data previously stored in the image ROM 82 in accordance with the image control program previously stored in the program ROM 81 based on a parameter set in the CPU 50. The work RAM 84 is implemented as temporary storage means for the image control CPU 83 to execute the image control program. The VDP 85 forms an image responsive to the display determined by the image control CPU 83 and outputs the image to the liquid crystal display 3. Accordingly, for example, the symbol rows 241 to 243 in FIG. 5, etc., are variable-displayed and stop-displayed on the liquid crystal display 3 (see FIG. 1). The video RAM 86 is implemented as temporary storage means for the VDP 85 to form an image.

Referring again to FIG. 3, the credit display frame 301 is connected to the CPU 50 through a credit display circuit 302, whereby the number of credit points storing the coins obtained by the player playing each game is displayed on the credit display frame 301.

LEDs 78 are also connected to the CPU 50 through an LED drive circuit 77. A large number of LEDs 78 are disposed on the front of the slot machine 1 and are lighted under the control of the LED drive circuit 77 based on a drive signal from the CPU 50 in displaying various effects. Further, a sound output circuit 79 and a speaker 80 are connected to the CPU 50. The speaker 80 produces various effect sounds in displaying various effects based on an output signal from the sound output circuit 79.

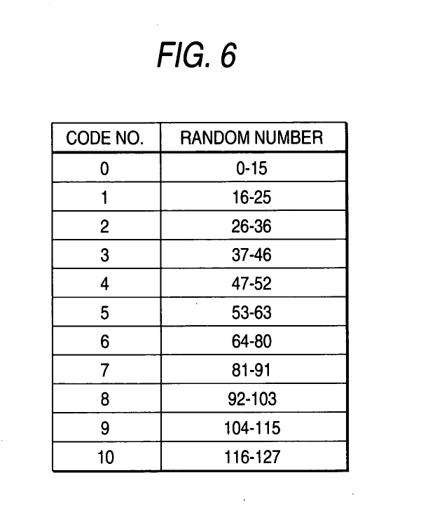

The lottery table used to determine the symbols to be stop-displayed on the activated pay line L for playing a game using the three variable display sections 22 to 24 with the slot machine will be discussed based on FIG. 6. FIG. 6 is a schematic representation to show the lottery table of the stop display symbols for playing a game using the three variable display sections.

The symbols to be stop-displayed on the activated pay line L are determined for each of the variable display sections 22 to 24. To do this, code numbers “0” to “10” are assigned to each of the symbol rows 241 to 243 of the variable display sections 22 to 24 shown in FIG. 5 in order from the top to the bottom, and the lottery table as shown in FIG. 6 is provided. The random number sampling circuit 56 samples three random numbers in a one-to-one correspondence with the variable display sections 22 to 24.

For convenience of the description, the symbol row 241 of the left variable display section 22 is described as “the left reel,” the symbol row 242 of the center variable display section 23 is described as “the center reel,” and the symbol row 243 of the right variable display section 24 is described as “the right reel.”

As for “the left reel” of the symbol row 241 of the left variable display section 22, if the random number sampled through the random number sampling circuit 56 is in the range of 0 to 15, blank 96 assigned to the code number “0” is stop-displayed on the activated pay line L as shown in the lottery table of FIG. 6. The lottery table of FIG. 6 is also used in a similar manner for the code numbers “0” to “10.”

“The center reel” of the symbol row 242 of the center variable display section 23 and “the right reel” of the symbol row 243 of the right variable display section 24 are also similar to “the left reel” of the symbol row 241 of the left variable display section 22 described above.

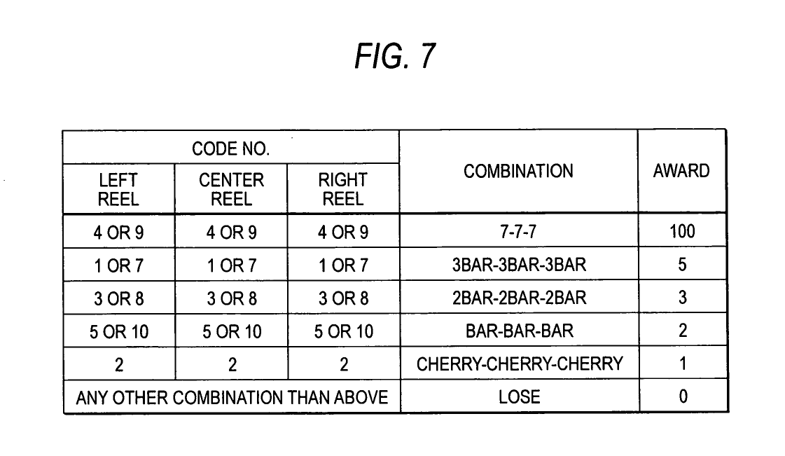

Next, the winning combination and its award for playing a game using the three variable display sections 22 to 24 with the slot machine 1 will be discussed based on FIG. 7. FIG. 7 is a schematic representation to show the winning combination and its award for playing a game using the three variable display sections. In FIG. 7, if the code numbers for “the left reel,” “the center reel,” and “the right reel” are all “4” or “9,” the player gets a winning combination of “7-7-7.” In this case, seven 94 is stop-displayed on the activated pay line L on the variable display sections 22 to 24 and the player gains an award of “100.” The table shown in FIG. 7 is also used in a similar manner for awards of “5,” “3,” “2,” and “1.”

When the code numbers for “the left reel,” “the center reel,” and “the right reel” are any other combination than the combinations (combinations when the award is “5,” “3,” “2,” “1”), “lose” occurs. In this case, any of triple BAR 91, cherry 92, double BAR 93, seven 94, single BAR 95, or blank 96 is stop-displayed on the activated pay line L in the variable display sections 22 to 24, but the player does not gain any award.

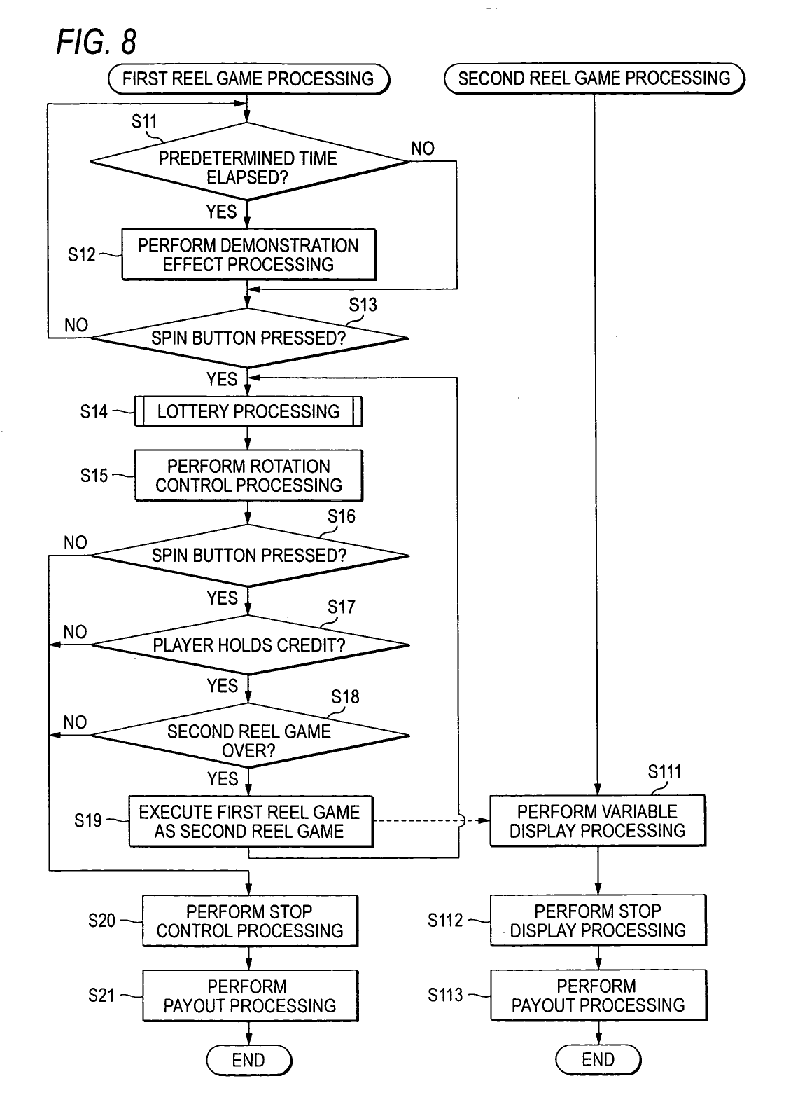

Subsequently, the main processing program executed in the slot machine 1 will be discussed based on FIG. 8. FIG. 8 is a flowchart of the main processing program made up of first reel game processing and second reel game processing. First, the first reel game processing will be discussed. At step 11 (S11), whether or not a predetermined time (for example, 15 seconds) has elapsed is determined. When not determined that the predetermined time has elapsed (NO at S11), the process proceeds to S13 without performing any operation; when determined that the predetermined time has elapsed (YES at S11), demonstration effect is performed on the liquid crystal display 3 at S12 and then the process proceeds to S13.

An example of the display state of the liquid crystal display 3 and the front panel 4 at the time is shown in display state A in FIG. 1. In display state A in FIG. 1, nothing is displayed on the liquid crystal display 3, but the demonstration effect can be displayed. Stop display of three symbols is performed on the variable display sections 22 to 24 on the front panel 4.

At S13, whether or not the player presses the spin (SPIN/REPEATBET) button 12, etc., is determined. Specifically, the determination is made by whether or not a switch signal output from the spin switch 58, the 1-BET switch 59, the 3-BET switch 60, or the 5-BET switch 61 as the spin (SPIN/REPEAT BET) button 12, the 1-BET button 11, the 3-BET button 13, or the 5-BET button 14 is pressed is accepted. When not determined that the player presses the spin (SPIN/REPEAT BET) button 12, etc., (NO at S13), the process returns to S11 and the above-described operation is repeated. When is determined that the player presses the spin (SPIN/REPEAT BET) button 12, etc., (YES at S13), the process proceeds to S14 even if the demonstration effect is being performed.

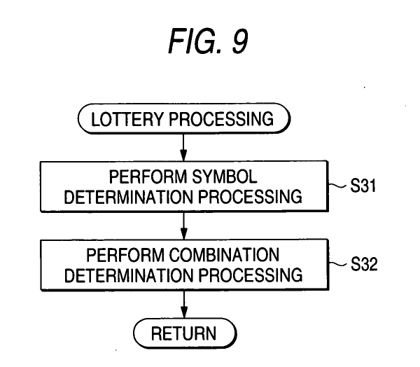

At S14, lottery processing is performed. Then, the lottery processing program will be discussed based on FIG. 9. FIG. 9 is a flowchart of the lottery processing program.

In FIG. 9, first the process proceeds to S31 and symbol determination processing is performed. Here, the symbols to be displayed stopped (stop-displayed) on the activated pay line L are determined for each of the variable display sections 22 to 24. Specifically, the random number sampling circuit 56 samples three random numbers in a one-to-one correspondence with the variable display sections 22 to 24, and the symbols to be stop-displayed are determined through the code numbers based on the lottery table of FIG. 6, as described above. When the symbols to be stop-displayed on the activated pay line L are determined, combination determination processing is performed at S32 and then the subroutine returns to the main processing program in FIG. 8 and the process proceeds to S15. In the combination determination processing, specifically the winning combination and its award are determined based on the table of FIG. 7 through the code numbers at S31 as described above.

Referring again to FIG. 8, at S15, rotation control processing is performed for starting rotation of all reels 220.

An example of the display state of the liquid crystal display 3 and the front panel 4 at the time is shown in display state B in FIG. 1. In display state B in FIG. 1, nothing is displayed on the liquid crystal display 3, but display of the demonstration effect may be continued from S12 described above. Various symbols are variably displayed on the variable display sections 22 to 24 on the front panel 4 while the symbols are scrolled from the upper direction to the lower direction.

When the process proceeds to S16, again whether or not the player presses the spin (SPIN/REPEAT BET) button 12, etc., is determined. The determination is also made in a similar manner to that at S13 described above. If it is not determined that the player presses the spin (SPIN/REPEAT BET) button 12, etc., (NO at S16), the process proceeds to S20.

At S20, stop control processing is performed for stopping rotation of the reels 220 corresponding to the variable display sections 22 to 24 so as to produce stop display of the symbols determined at S14 on the activated pay line L after the expiration of a predetermined time (for example, one second) since the spin (SPIN/REPEAT BET) button 12, etc., was pressed.

The display state of the liquid crystal display 3 and the front panel 4 at this time becomes display state A in FIG. 1, for example.

Then, the process proceeds to S21 and payout processing is performed for paying out coins, etc., corresponding to the award preset based on the table in FIG. 7 in accordance with the winning combination of the symbols stop-displayed on the activated pay line L in the variable display sections 22 to 24. Then, the first reel game processing is terminated. Here, however, the coins obtained by the player playing the game are paid out in the form in which the points equivalent to the number of the coins are added to the credit.

That is, the expression “first reel game” is used to mean a slot game using the symbols variable-displayed and stop-displayed on the variable display sections 22 to 24 (reels 220) of the front panel 4.

Therefore, when the CPU 50 executes S14 in FIG. 8, the CPU 50 serves as “lottery means.”

When the CPU 50 executes S15 in FIG. 8, the CPU 50 serves as “variable display control means.”

When the CPU 50 executes S20 in FIG. 8, the CPU 50 serves as “stop display control means.”

On the other hand, when determined that the player presses the spin (SPIN/REPEAT BET) button 12, etc., (YES at S16), the process proceeds to S17.

At S17, whether or not the user holds credit points is determined. When determined that the user does not hold any credit point (NO at S17), the process proceeds to S20 and steps S20 and S21 are executed. When determined that the user holds credit points (YES at S17), the process proceeds to S18.

At S18, whether or not second reel game is over is determined. In this case, when the display state is the display state C shown in FIG. 1, namely, when various symbols are variably displayed on the variable display sections 322 to 324 displayed on the liquid crystal display 3 while the symbols are scrolled from the upper direction to the lower direction, when determined that the second reel game is not over; otherwise, for example, when the display state is as such as the display states A, B, or D in FIG. 1, it is determined that the second reel game is over. Variable display of symbols on the liquid crystal display 3 and the like are described later together with second reel game processing.

When determined that the second reel game is not over (NO at S18), the process proceeds to S20 and steps S20 and S21 are executed. When determined that the second reel game is over (YES at S18), the process proceeds to S19.

At S19, the first reel game is executed as the second reel game. The expression “the first reel game is executed as the second reel game” at S19 is used to mean reperforming on the liquid crystal display 3 the state in which various symbols are variably displayed on the variable display sections 22 to 24 of the front panel 4 while the symbols are scrolled from the upper direction to the lower direction (the state when S19 is reached) as the state is carried on.

Then, in the main processing program in FIG. 8, second reel game processing is executed and first at S111, variable display processing is performed. Specifically, the variable display sections 322 to 324 and an activated pay line M are displayed on the liquid crystal display 3 as shown in display state C in FIG. 1 and further various symbols are variably displayed on the variable display sections 322 to 324 while the symbols are scrolled from the upper direction to the lower direction so as to match the rotation state of each reel 220 detected at the time.

Accordingly, the state in which various symbols are variably displayed on the variable display sections 22 to 24 of the front panel 4 while the symbols are scrolled from the upper direction to the lower direction (the state when S19 is reached) is smoothly reperformed on the liquid crystal display 3 without a sense of incompatibility as the state is carried on.

The variable display sections 322, 323, and 324 and the activated pay line M on the liquid crystal display 3 correspond to the variable display sections 22, 23, and 24 and the activated pay line L on the front panel 4.

Then, the process proceeds to S112 and stop display processing is performed. Here, the symbols determined in the lottery processing at S14 most recently executed before execution of S19 in the first reel game processing as a trigger of executing the second reel game processing are stop-displayed on the activated pay line M in the variable display sections 322 to 324 on the liquid crystal display 3.

The display state of the liquid crystal display 3 and the front panel 4 at this time becomes display state D shown in FIG. 1, for example.

Then, the process proceeds to S113 and payout processing is performed for paying out coins (game medium) in accordance with the award preset based on the table in FIG. 7 in accordance with the winning combination of the symbols stop-displayed on the activated pay line M in the variable display sections 322 to 324 on the liquid crystal display 3. Then, the second reel game processing is terminated. Here, however, the coins obtained by the player playing the game are paid out in the form in which the points equivalent to the number of the coins are added to the credit.

That is, the expression “second reel game” is used to mean a slot game using the symbols variable-displayed and stop-displayed on the variable display sections 322 to 324 on the liquid crystal display 3.

In the first reel game processing described above, after the first reel game is executed as the second reel game at S19, the process returns to S14 and the subsequent lottery processing, etc., is again performed, whereby new “first reel game” is performed. However, when the new “first reel game” is entered (when the lottery processing at S14 is a gain performed), all reels 220 are already in rotation state. Therefore, then, when the rotation control processing at S15 is again performed, the rotation state of all reels 220 is maintained without stop. However, all reels 220 may be once stopped at the origin position not involved in the slot game result and then rotation of all reels 220 may be again started.

Then, when the process again proceeds to S20 with S19 being skipped, the display state of the liquid crystal display 3 and the front panel 4 at this time becomes display state A shown in FIG. 1, for example. In display state A, noting is displayed on the liquid crystal display 3, but the symbols stop-displayed on the variable display sections 322 to 324 and the activated pay line M may be continuously displayed as the result of the “second reel game.” On the other hand, when the process does not proceed to S20 and again goes to S19, the display state of the liquid crystal display 3 and the front panel 4 at this time becomes display state C in FIG. 1, for example.

Therefore, when the CPU 50 performs S16, S17, S18, the CPU 50 serves as “reception means.”

When the CPU 50 performs S19, S111, S112, the CPU 50 serves as “game continuation means.”

As described above in detail, in the slot machine 1 according to the embodiment, when no game is advanced, three symbols are stop-displayed on each of the variable display sections 22 to 24 on the front panel 4 as shown in display state A in FIG. 1, for example. As the player presses the spin (SPIN/REPEAT BET) button 12, etc., three symbols are variably displayed on each of the variable display sections 22 to 24 on the front panel 4 as shown in display state B shown in FIG. 1, for example, and Nth (N=any of 1, 2, . . . ) game proceeds.

Then, when the player does not press the spin (SPIN/REPEAT BET) button 12, etc., three symbols are stop-displayed on the activated pay line L in the variable display sections 22 to 24 on the front panel 4 as shown in display state A in FIG. 1, for example, and the result of the Nth game is shown.

On the other hand, as the player presses the spin (SPIN/REPEAT BET) button 12, while three symbols are variably displayed on each of the variable display sections 22 to 24 on the front panel 4, three symbols are variably displayed on each of the variable display sections 322 to 324 on the liquid crystal display 3. That is, the Nth game is carried on from the front panel 4 to the liquid crystal display 3, and the Nth game proceeds in the liquid crystal display 3. At the same time, variable display of three symbols is continued on each of the variable display sections 22 to 24 on the front panel 4 and the (N+1)st game proceeds, as shown in display state C in FIG. 1.

Then, when the player does not press the spin (SPIN/REPEAT BET) button 12, etc., three symbols are stop-displayed on the activated pay line M in the variable display sections 322 to 324 on the liquid crystal display 3 as shown in display state D in FIG. 1, for example, and the result of the Nth game is shown and further three symbols are stop-displayed on the activated pay line L in the variable display sections 22 to 24 on the front panel 4 as shown in display state A in FIG. 1, for example, and the result of the (N+1)st game is shown.

On the other hand, while three symbols are stop-displayed on the activated pay line M in the variable display sections 322 to 324 on the liquid crystal display 3 and the result of the Nth game is shown and three symbols are variably displayed on each of the variable display sections 22 to 24 on the front panel 4 and the (N+1)st game proceeds, as shown in display state D in FIG. 1, for example, as the player presses the spin (SPIN/REPEAT BET) button 12, etc., three symbols are variably displayed on each of the variable display sections 322 to 324 on the liquid crystal display 3. That is, the (N+1)st game is carried on from the front panel 4 to the liquid crystal display 3, and the (N+1)st game is proceeded in the liquid crystal display 3. At the same time, variable display of three symbols is continued on each of the variable display sections 22 to 24 on the front panel 4 and the (N+2)nd game proceeds, as shown in display state C in FIG. 1.

After this, likewise, the (N+1)st game, the (N+2)nd game, . . . are performed on the liquid crystal display 3 and the front panel 4.

That is, in the slot machine 1 according to the embodiment, as shown in display state B in FIG. 1, for example, while the present game is performed as symbols are variably displayed on each of the variable display sections 22 to 24 (reels 220) on the front panel 4 (S15), when the player presses the spin (SPIN/REPEAT BET) button 12, etc., for entering a start command of the next game (YES at S16), only when it is determined that the player holds credit points (YES at S17) and it is determined that the second reel game is over (YES at S18), the variable display and stop display of the symbols in the present game are carried on from the variable display sections 22 to 24 (reels 220) on the front panel 4 to the variable display sections 322 to 324 on the liquid crystal display 3 (S19, S111, S112) and variable display and stop display of symbols in the next game are performed on the variable display sections 22 to 24 (reels 220) on the front panel 4 as shown in display state C in FIG. 1, for example, so that it is made possible to start the next game and also display the effect of the next game (variable display, stop display of each symbol) while displaying the effect of the present game being continued (variable display, stop display of each symbol).

In the slot machine 1 according to the embodiment, the present game and the next game proceed at the same time, so that the game availability is also improved.

It is to be understood that the invention is not limited to the specific embodiment thereof and various modifications and changes may be made without departing from the spirit and the scope of the invention.

For example, in the slot machine 1 according to the embodiment, as shown in display state C in FIG. 1, for example, while the present game is performed as symbols are variably displayed on each of the variable display sections 22 to 24 (reels 220) on the front panel 4 (S15), even when the player presses the spin (SPIN/REPEAT BET) button 12, etc., for entering a start command of the next game (YES at S16), when determined that the second reel game is not over (NO at S18) as symbols are variably displayed on the variable display sections 322 to 324 on the liquid crystal display 3, the process does not proceed to S19 and the next game is not started.

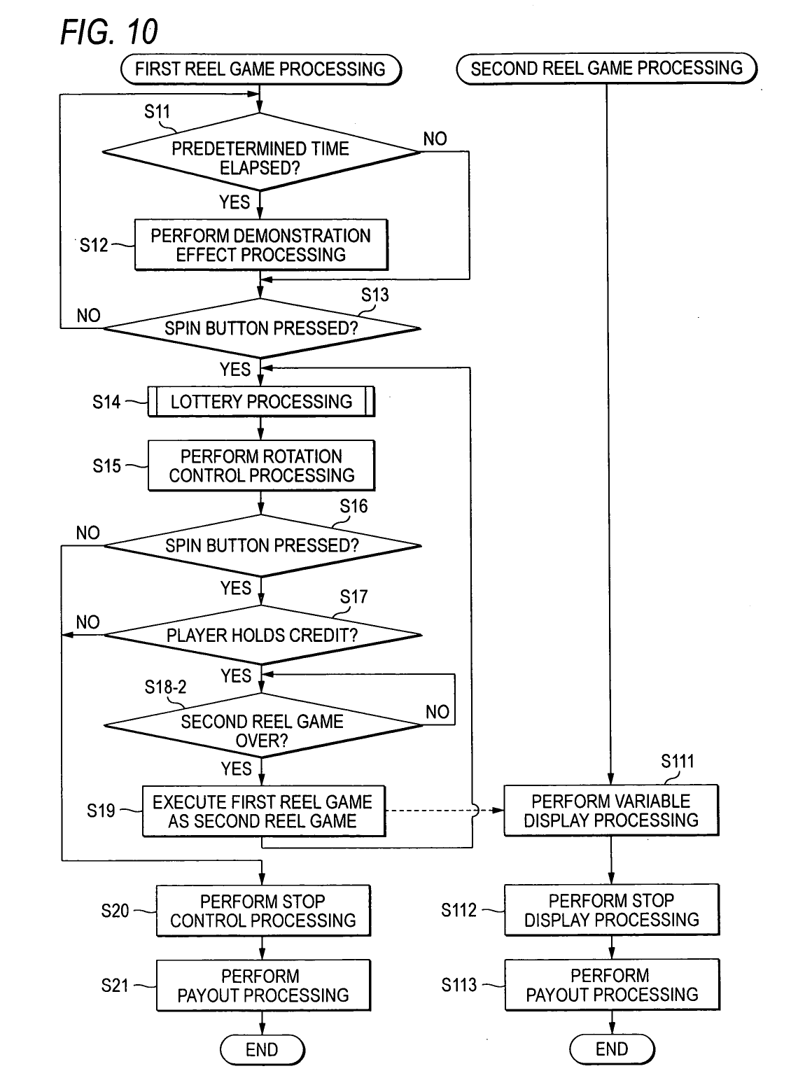

The determination processing at S18 in FIG. 8 may be replaced with determination processing at S18-2 in a flowchart of a main processing program in FIG. 10 for waiting until the second reel game is over (YES at S18-2) and then starting the next game at S19.

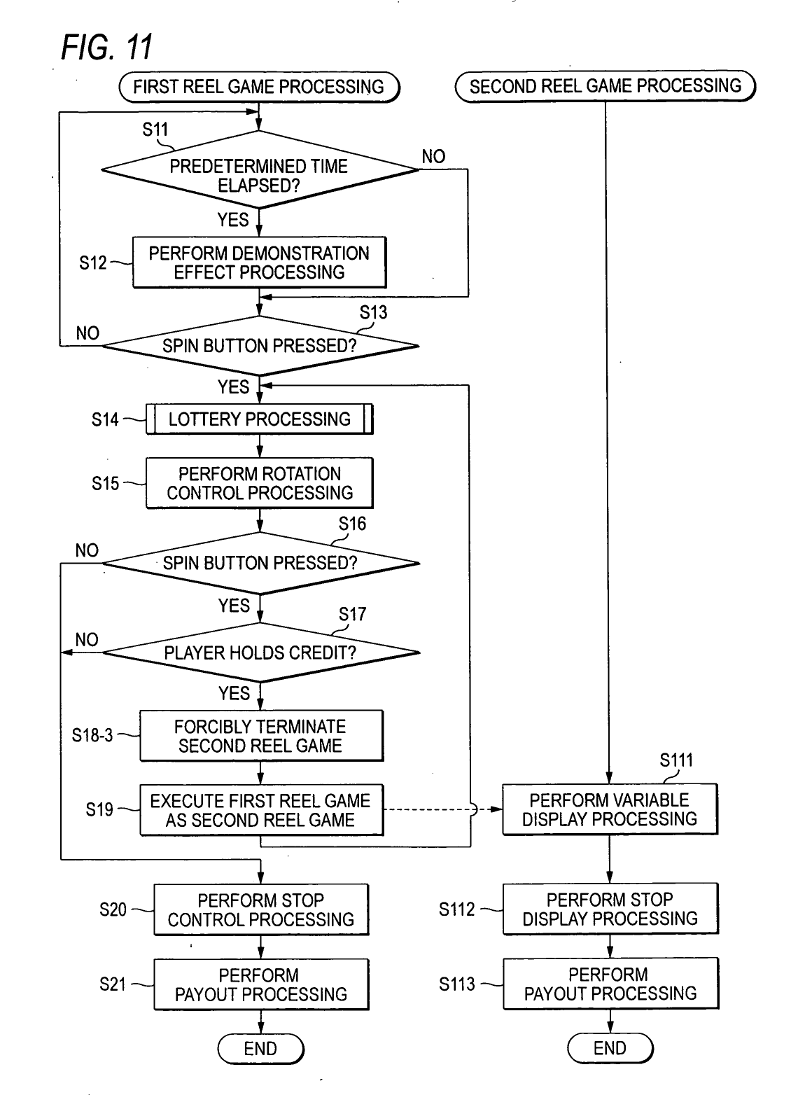

The determination processing at S18 in FIG. 8 may be replaced with processing at S18-3 in a flowchart of a main processing program in FIG. 11 for immediately performing stop display of symbols on the variable display sections 322 to 324 on the liquid crystal display 3 without waiting for execution of the stop display processing at S112, thereby forcibly terminating the second reel game and then starting the next game at S19.

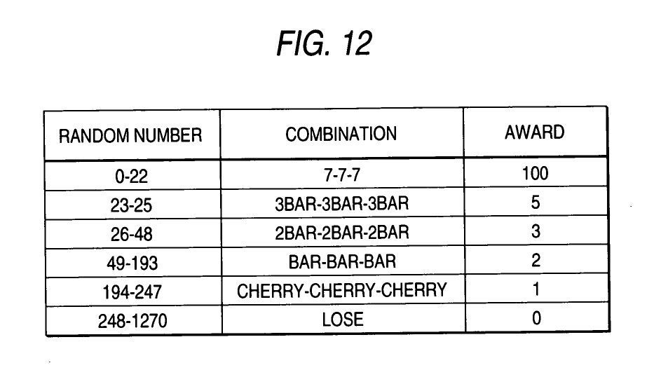

In the slot machine 1 according to the embodiment, in the lottery processing at S14, the symbols to be stop-displayed on the activated pay line L are determined for each of the variable display sections 22 to 24 by the random number sampled through the random number sampling circuit 56 as shown in FIGS. 6 and 7. However, all symbols to be stop-displayed on the activated pay line L in the variable display sections 22 to 24 may be determined by the random number sampled through the random number sampling circuit 56. To do this, a winning combination lottery table shown in FIG. 12 is used. FIG. 12 is a schematic representation to show the winning combination lottery table and awards.

In FIG. 12, the range of the random numbers used in the winning combination lottery table is 0 to 1270 and if the random number sampled through the random number sampling circuit 56 is in the range of 0 to 22, the player gets a winning combination of “7-7-7” and gains an award of “100.” The table shown in FIG. 12 is also used in a similar manner for awards of “5,” “3,” “2,” and “1.”

When the sampled random number is in the range of 248 to 1270, “lose” occurs. In this case, any other symbol combination than the symbol combinations described above is stop-displayed on the activated pay line L in the variable display sections 22 to 24, but the player does not gain any award.

In the slot machine 1 according to the embodiment, the variable display and the stop display of the symbols on the variable display sections 22 to 24 on the front panel 4 are performed as the reels 220 are rotated. However, the variable display and the stop display of the symbols in the front panel 4 may be performed using video reels. On the other hand, the variable display and the stop display of the symbols on the variable display sections 322 to 324 on the liquid crystal display 3 are performed using video reels. However, they the variable display and the stop display of the symbols in the liquid crystal display 3 may be performed by mechanical reels.

In the slot machine 1 according to the embodiment, the player plays only base games, but may play a free game after playing a base game, for example, just after S21 or S113 in FIG. 8, 10, or 11. Generally, the free game often is a game advantageous for the player. For example, when the base game transitions to a free game provided that a specific symbol is stop-displayed, etc., the player can continue to play 10 games, 20 games, or 30 games in response to the rank of the free game without betting any game medium. In the free game, it is a common practice to set a high winning probability for various wining combinations and therefore the player often can gain a large number of game medium.

As described in detail with reference to the embodiment, in the gaming machine of the present invention, when a start command for the next game is accepted when the present game is being performed as the symbols are variably displayed on the first image display device and the game continuation condition is satisfied, the second image display device is caused to carry on the variable display and the stop display of the symbols in the present game from the first image display device and the variable display and the stop display of the symbol in the next game are performed on the first image display device. Thus, the gaming machine can start the next game and also display the effect of the next game while displaying the effect of the present game being continued.

The foregoing description of the embodiment has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

What is claimed is:

1. A gaming machine comprising:
a first image display device;
a second image display device;
a processor that performs a process for providing a player a game by controlling the first image display device and the second image display device to display a progress of the game; and
an operation unit that allows the player to input operations including a start command to start the game,
wherein the processor performs the process comprising:
performing a lottery to determine a stop state of symbols when the start command is input through the operation unit;
controlling the first image display device to start performing a variable display of a plurality of symbols when the start command is input through the operation unit;
accepting a next start command input through the operation unit for starting a next game, while the variable display of a present game is performed in the first image display device;
continuing the present game in the second image display device by controlling the second image display device to carry on the variable display performed in the first image display device, when the next start command is accepted;
controlling the first image display device to start performing the variable display for the next game while the present game is continued in the second image display device;
controlling the second image display device to stop performing the variable display and to display the symbols in the stop state determined by the lottery; and
performing a payout of an award to the player in accordance with the stop state of the symbols.

2. The gaming machine according to claim 1, wherein the processor performs accepting the next start command while the variable display of the present game is performed and while a game continuation condition is satisfied, the game continuation condition including a completion of stop performing the variable display for a previous game in the second image display device.

3. A gaming machine comprising:
a first image display device;
a second image display device;
a processor that performs a process for providing a player a game by controlling the first image display device and the second image display device to display a progress of the game; and
an operation unit that allows the player to input operations including a start command to start the game,
wherein the processor performs the process comprising:
performing a lottery to determine a stop state of symbols when the start command is input through the operation unit;
controlling the first image display device to start performing a variable display of a plurality of symbols when the start command is input through the operation unit;
accepting a next start command input through the operation unit for starting a next game, while the variable display of a present game is performed in the first image display device;
continuing the present game in the second image display device by controlling the second image display device to carry on the variable display performed in the first image display device, when the next start command is accepted;
controlling the first image display device to start performing the variable display for the next game while the present game is continued in the second image display device;
controlling the second image display device to stop performing the variable display and to display the symbols in the stop state determined by the lottery; and
performing a payout of an award to the player in accordance with the stop state of the symbols,
wherein the processor performs continuing the present game in the second image display device and controlling the first image display device to start performing the variable display for the next game, after completion of stop performing the variable display for a previous game in the second image display device, when the next start command is accepted while the variable display for the previous game is performed in the second image display device.

4. A gaming machine comprising:
a first image display device;
a second image display device;
a processor that performs a process for providing a player a game by controlling the first image display device and the second image display device to display a progress of the game; and
an operation unit that allows the player to input operations including a start command to start the game,
wherein the processor performs the process comprising:
performing a lottery to determine a stop state of symbols when the start command is input through the operation unit;
controlling the first image display device to start performing a variable display of a plurality of symbols when the start command is input through the operation unit;
accepting a next start command input through the operation unit for starting a next game, while the variable display of a present game is performed in the first image display device;
continuing the present game in the second image display device by controlling the second image display device to carry on the variable display performed in the first image display device, when the next start command is accepted;
controlling the first image display device to start performing the variable display for the next game while the present game is continued in the second image display device;
controlling the second image display device to stop performing the variable display and to display the symbols in the stop state determined by the lottery; and
performing a payout of an award to the player in accordance with the stop state of the symbols,
wherein the processor performs continuing the present game in the second image display device and controlling the first image display device to start performing the variable display for the next game, after completion of stop performing the variable display for a previous game in the second image display device, when the next start command is accepted while the variable display for the previous game is performed in the second image display device, and
wherein the processor immediately performs controlling the second image display device to stop performing the variable display for the previous game, when the next start command is accepted while the variable display for the previous game is performed in the second image display device.

5. A method for providing a player a game with a gaming machine by controlling a first image display device and a second image display device that are provided on the gaming machine to display a progress of the game, the method comprising:
performing a lottery to determine a stop state of symbols when a start command is input by the player;
controlling the first image display device to start performing a variable display of a plurality of symbols when the start command is input by the player;
accepting a next start command input through the operation unit for starting a next game, while the variable display of a present game is performed in the first image display device;
continuing the present game in the second image display device by controlling the second image display device to carry on the variable display performed in the first image display device, when the next start command is accepted;
controlling the first image display device to start performing the variable display for the next game while the present game is continued in the second image display device;
controlling the second image display device to stop performing the variable display and to display the symbols in the stop state determined by the lottery; and
performing a payout of an award to the player in accordance with the stop state of the symbols.

6. The method according to claim 5, further comprising performing the acceptance of the next start command while the variable display of the present game is performed and while a game continuation condition is satisfied, the game continuation condition including a completion of stop performing the variable display for a previous game in the second image display device.

7. The method according to claim 5, further comprising performing the continuation of the present game in the second image display device and control of the first image display device to start performing the variable display for the next game, after completion of stop performing the variable display for a previous game in the second image display device, when the next start command is accepted while the variable display for the previous game is performed in the second image display device.

8. The method according to claim 7, further comprising immediately performing the control of the second image display device to stop performing the variable display for the previous game, when the next start command is accepted while the variable display for the previous game is performed in the second image display device.
